(19) United States
(12) Patent Application Publication
(10) Pub. No.: US 2021/0044435 A1
(43) Pub. Date: Feb. 11, 2021

(54) METHOD FOR TRANSMITTING DATA FROM A MOTOR VEHICLE AND METHOD FOR ANOTHER VEHICLE TO RECEIVE THE DATA THROUGH A RADIO COMMUNICATION CHANNEL

(71) Applicant: PSA AUTOMOBILES SA, Poissy (FR)

(72) Inventors: Sylvain PATUREAU MIRAND, Gometz Le Chatel (FR); Antoine BOULANGER, L'Hay Les Roses (FR)

(21) Appl. No.: 16/980,374

(22) PCT Filed: Feb. 21, 2019
(86) PCT No.: PCT/FR2019/050396

§ 371 Date: Sep. 11, 2020

(30) Foreign Application Priority Data
Mar. 19, 2018 (FR) 1852338

(51) Int. Cl. H04L 9/08; H04L 9/32

(52) U.S. Cl. CPC H04L 9/0869; H04L 9/3228; H04L 9/0877

(57) ABSTRACT

The transmission method comprises: a step in which the vehicle obtains, from a distribution entity, a plurality of series of numbers each containing a base gᵢ, a prime number pᵢ, a first key Zᵢ, wherein Zᵢ=gᵢ^{z}^{ᵢ} modulo pᵢ, wherein zᵢ is a secret number, an associated validity number Vᵢ, and stores in memory the N series of numbers; a step of generating a random number a; a step of calculating a second key K^{aZ}^{ᵢ} wherein K^{aZ}^{ᵢ}=Zᵢ^{a} modulo pᵢ; a step of creating a message M, during which the vehicle A inserts in the message M the validity number Vᵢ; the second group of numbers a, pᵢ and gᵢ encrypted by means of the first key (Zᵢ), in a header of the message, and the data, in a body of the message; and the vehicle performs a cryptographic operation on the message M using the second key (K^{aZ}^{ᵢ}); and a step of transmitting the message M created by the vehicle through a radio communication channel.

### CROSS-REFERENCE TO RELATED APPLICATIONS

This application is the US National Stage under 35 USC § 371 of International Application No. PCT/FR2019/050396, filed Feb. 21, 2019, which claims priority to French Application No. 1852338 filed Mar. 19, 2018, both of which are incorporated herein by reference.

### BACKGROUND

The present invention relates in general to a method for securely transmitting data from a motor vehicle A through a communication channel, and to a method for a motor vehicle B to securely receive data through a communication channel.

Communications between motor vehicles are subject to legal provisions that regulate the freedom to process personal data. In France, for example, the national data protection agency CNIL (Commission Nationale de l'Informatique et des Libertés) ensures that communicating motor vehicles are compliant with France's data protection law (loi Informatique et Libertés).

With respect to communication between motor vehicles, the challenge posed is that of ensuring the authenticity, integrity and anonymization of the data. For example, it has to be impossible to track a vehicle by monitoring the data that it transmits.

One known solution for anonymizing the data transmitted by a vehicle, while at the same time ensuring the confidentiality and integrity of these data, is based on the use of public and private key certificates. This solution requires a PKI infrastructure capable of generating a very large number of certificates. With such a system, it is estimated that each communicating vehicle has to use a new certificate every 800 meters. In a country as large as France, for example, billions of certificates would therefore have to be generated each year, meaning hundreds of servers would need to be deployed throughout France.

### SUMMARY

The present invention aims to improve the situation.

For this purpose, a method is disclosed for transmitting data from a motor vehicle (A) through a radio communication channel. In accordance with a first aspect of the method, the method includes
an obtaining step during which said vehicle obtains, from a distribution entity, a plurality of series of numbers each containing:
   a base gᵢ,
   a prime number pᵢ,
   a first key Zᵢ, said first key Zᵢ being the result of a calculation comprised of raising the base gᵢ to a power zᵢ, where zᵢ is a secret number selected by said distribution entity, in order to obtain gᵢ^{z}^{ᵢ}, and then calculating gᵢ^{z}^{ᵢ} modulo pᵢ,
   a validity number Vᵢ associated with a first group of numbers containing pᵢ, gᵢ and Zᵢ, where i is an integer which represents an index of said series of numbers, with i=1, 2, . . . N;
   and stores in memory the N series of numbers in a table;
a step of generating a random number a;
a step of calculating a second key K^{aZ}^{ᵢ} by raising the first key Z to the power a, in order to obtain Zᵢ^{a}, and then calculating Zᵢ^{a} modulo pᵢ;
a step of creating a message M carrying the data from a first group of numbers containing pᵢ, gᵢ and Zᵢ, during which step the vehicle A:
   encrypts a second group of numbers containing a, pᵢ and gᵢ by means of the first key Zᵢ;
   inserts into said message M the validity number Vᵢ associated with the first key Zᵢ, the second group of numbers a, pᵢ and gᵢ encrypted by means of the first key Zᵢ in a header of the message, and the data, in a body of the message; and
   performs a cryptographic operation on said message M using the second key K^{aZ}^{ᵢ};
a step of transmitting the message M created by the vehicle through said communication channel.

The present method makes it possible to anonymize the communications of the vehicle, while at the same time ensuring the confidentiality and integrity of the message. The cryptographic means used perform well, are very quick and require few computing resources.

Advantageously, the second key K^{aZ}^{ᵢ} is a single-use key intended to be used exclusively for the message M.

Also advantageously, the vehicle performs at least one of the cryptographic operations from the group comprising an operation for encrypting the content of the body of the message by means of the second key K^{aZ}^{ᵢ} and a cryptographic operation for signing the message by means of the second key K^{aZ}^{ᵢ}.

In one particular embodiment, the vehicle performs said cryptographic operation using the second key K^{aZ}^{ᵢ} exclusively on the body of the message.

The vehicle can insert a random number into the body of the message.

Also disclosed is a method for a second vehicle to receive a message M transmitted by a first vehicle, through a communication channel, according to the transmission method described above. The reception method includes:
an obtaining step during which said second vehicle obtains, from a distribution entity, and stores in memory, in a table, a plurality of series of numbers each containing
   a base gᵢ,
   a prime number pᵢ,
   a first key Zᵢ, said first key Zᵢ being the result of a calculation comprised of raising the base gᵢ to a power zᵢ, where zᵢ is a secret number selected by said distribution entity, in order to obtain gᵢ^{z}^{ᵢ}, and then calculating gᵢ^{z}^{ᵢ} modulo pᵢ,
   a validity number Vᵢ associated with a first group of numbers containing pᵢ, gᵢ and Zᵢ, where i is an integer which represents an index of said series of numbers, with i=1, 2, . . . , N;
a step of extracting the validity number V, from the received message M;
a step of extracting the first key Zᵢ associated with the validity number Vᵢ from the table stored in memory;
a step of decrypting the header of the message by means of the first key Zᵢ, in order to obtain the numbers a, pᵢ and gᵢ;
a step of calculating a second key K^{aZ}^{ᵢ} comprised of raising the first key Zᵢ to the power a, in order to obtain Zᵢ^{a}, and then calculating Zᵢ^{a} modulo pᵢ,
at least one step of cryptographically processing the received message M by means of the second key K^{aZ}^{ᵢ}.

Advantageously, when the message M is signed, the second vehicle verifies the authenticity of the message M by verifying the validity of the signature by means of the second key K^{aZ}^{ᵢ}.

Also advantageously, when the message is encrypted, the second vehicle decrypts the message by means of the second key K^{aZ}^{ᵢ} as a decryption key.

Another aspect of the invention relates to a device for securing radio communications for a motor vehicle, comprising means designed for carrying out the steps of the transmission method and the steps of the reception method, as defined above.

Lastly, a motor vehicle including a security device as described above is disclosed.

### DESCRIPTION OF THE FIGURES

Other features and advantages of the present invention will become clearer upon reading the following detailed description of an embodiment of the invention, given by way of non-limiting example and illustrated by the appended drawings, in which:

FIG. 1 shows a phase of obtaining series of numbers by two vehicles A and B from a distribution entity BO (back office), according to a particular embodiment;

FIG. 2 shows a particular embodiment of the transmission method and the reception method;

FIG. 3 shows substeps of a step of preparing a message M carrying data to be transmitted;

FIG. 4 is a functional block diagram of a vehicle (in this case the vehicle A) configured to carry out the transmission method and the reception method from FIG. 2.

### DETAILED DESCRIPTION

Disclosed is a method of securing the communications of a communicating motor vehicle. More particularly, a method is disclosed for a motor vehicle to securely transmit data through a communication channel, to a method for a motor vehicle to securely receive data through a communication channel, and to a method for securely transmitting data between a first motor vehicle and a second motor vehicle.

By way of illustrative example, a method is described for transmitting data from a motor vehicle A, referred to as the transmitter, to a motor vehicle B, referred to as the receiver. The method applies more generally, however, to the transmission of data from a motor vehicle through a communication channel, and to the reception of data by a motor vehicle through a communication channel.

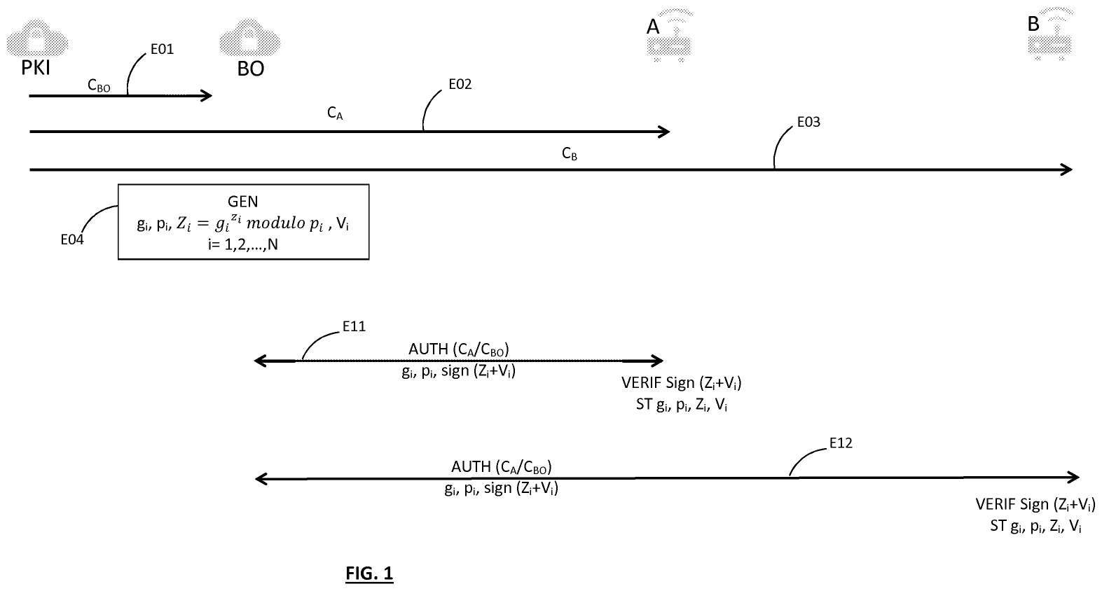

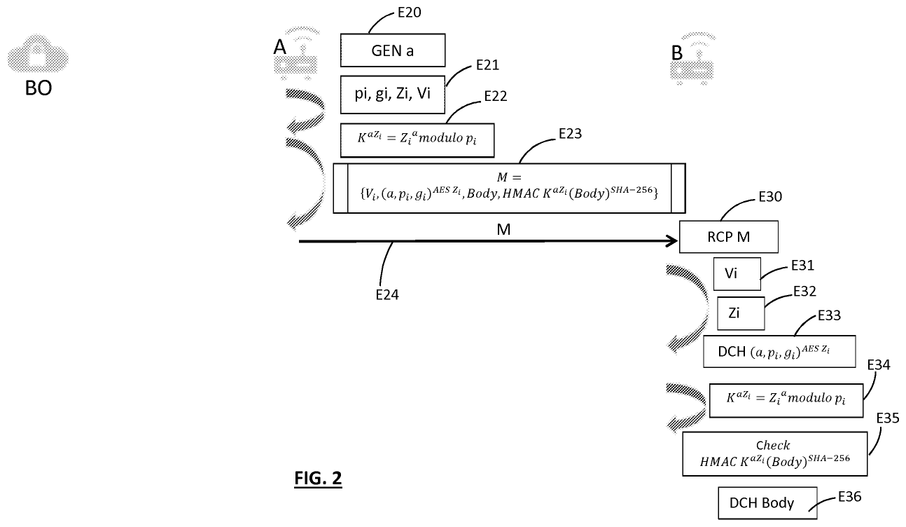

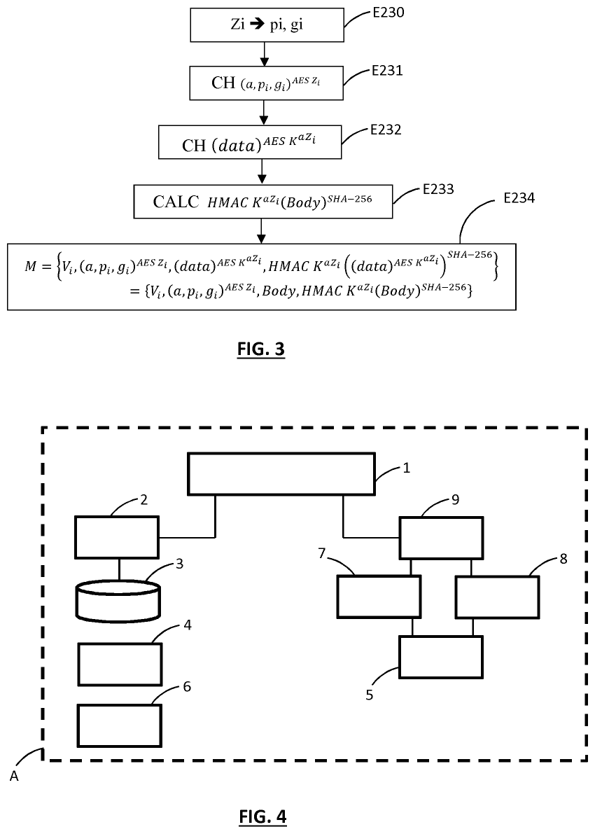

FIG. 1 shows an illustrative embodiment of a system for carrying out the transmission method and the reception method. The system comprises a public key infrastructure (PKI), a distribution entity (for example a server), also referred to as the back-office server (BO), a motor vehicle A and a motor vehicle B.

Before any data are transmitted or received by the vehicles A and B, each of the entities, i.e., the server BO, the vehicle A and the vehicle B, obtains a certificate containing a public and private key pair from the infrastructure PKI. Thus, during a first initial step E01 of obtaining certificates, the back-office server BO obtains a certificate C_{BO} containing a public and private key pair from the infrastructure PKI. During a second initial step E02 of obtaining certificates, the vehicle A obtains a certificate C_{A} containing a public and private key pair from the infrastructure PKI. Finally, during a third initial step E03 of obtaining certificates, the vehicle B obtains a certificate C_{B} containing a public and private key pair from the infrastructure PKI. The steps E01, E02 and E03 are carried out in a manner known to a person skilled in the art.

In order to ensure the trackability of the communications, random numbers generated within the vehicles (as described below) are sent to the server BO.

In this case, the certificates are intended for allowing secured communications to be established between each of the entities comprising the vehicle A, the vehicle B and the back-office server BO. Alternatively, the communications between each vehicle A, B and the back-office server BO could be secured using a username and password or by any other security method.

The back-office server BO generates series of numbers, for example N series of numbers (which are different from one another), during a step E04. The index of each series is denoted “i,” where i is an integer between 1 and N. Each series of numbers of index i contains the following elements:
a base gᵢ,
a prime number pᵢ,
a first key Zᵢ,
a validity number V, associated with said first key Zᵢ, and more precisely a first group of numbers containing pᵢ, gᵢ and Zᵢ.

The first key Z is generated from a secret number z, selected or generated by the back-office server BO and using the Diffie-Hellman key exchange cryptographic algorithm with the base gᵢ and the prime number pᵢ. More precisely, the calculation of the first key Zᵢ comprises raising the base gᵢ to a power zᵢ, in order to obtain gᵢ^{z}^{ᵢ}, and then calculating gᵢ^{z}^{ᵢ} modulo pᵢ. The number zᵢ is advantageously a random number generated by the back-office server BO.

The validity Vᵢ is an identifier, for example a number assigned to the series of numbers of index i, and uniquely identifies said series. This number is a sequence of X digits (each digit being a natural number between 0 and 9), where X is sufficiently large to ensure unique identification of the series of index i. For example, X is greater than or equal to 20, preferably greater than or equal to 30.

Each vehicle A (B) then performs a step E11 (E12) of obtaining series of numbers, prior to establishing secured and anonymized communications, for the purpose of obtaining the series of numbers generated by the back-office server and intended for securing and anonymizing the communications. The step E11 of obtaining series of numbers, carried out by the vehicle A, will now be described.

The step E11 comprises a first substep of mutual authentication between the vehicle A and the back-office server BO. During this first substep, the vehicle A connects to the back-office server BO and the two entities A and BO authenticate one another by means of their respective certificates C_{A} and C_{BO}. Once mutual authentication is achieved, during a second substep, the vehicle A transmits a request to the back-office server BO to obtain a plurality of series of numbers. During a third substep, the vehicle A receives, in response to its request, an initialization message containing the N series of numbers (gᵢ, pᵢ, Zᵢ, Vᵢ), with i=1, . . . N. The initialization message is advantageously signed by the back-office server BO by means of its certificate C_{BO}. In one particular embodiment, the initialization message is partially signed. For example, only the part of the message containing Zᵢ and Vᵢ is signed. During a fourth substep, the vehicle A verifies the signature of the message by means of the public key of the server BO, in order to verify its authenticity. If the message is successfully authenticated, during a fifth substep, the vehicle A stores in memory, in a table, the series of numbers retrieved from the back-office server BO. If authentication fails, the step of obtaining the series of numbers is interrupted.

The initialization message can also contain, for each series of numbers, temporal information relating to the use of the key Zᵢ, for example a use start date for the key Zᵢ. The keys can in fact have a predefined limited validity starting from this use start date.

The initialization step which has just been described is also carried out in the same way by the vehicle B, during an initialization step E12.

Once the steps E11 and E12 of obtaining series of numbers have been carried out, each vehicle A and B has, in memory, a set of series of numbers (gᵢ, pᵢ, Zᵢ, Vᵢ), with i=1, . . . , N.

The secured transmission of data from the vehicle A to the vehicle B, through a transmission channel, according to a particular embodiment, will now be described. The transmission of the data from the vehicle A to the vehicle B includes a method for the vehicle A to transmit the data and a method for the vehicle B to receive the data.

In the embodiment described, the data are both encrypted and signed. The encryption makes it possible to ensure the confidentiality of the transmitted data. The signature makes it possible to ensure the integrity of the electronic message and authenticate the author of said message (i.e. the transmitter vehicle A in this case), while at the same time ensuring the anonymization of the data.

### Method for the Vehicle A to Transmit the Data

In order to transmit the data, the vehicle A creates a message M for carrying said data. Prior to the message M being created, the vehicle A generates a single-use encryption key (referred to in the following as the “second encryption key”) intended for being used to encrypt and/or sign the message M exclusively.

### Generation of the Single-Use Encryption Key

The generation of the single-use key comprises three steps E20 to E22.

During the first step E20, the vehicle A generates a random number a, and then, during the second step E21, extracts, from the storage table, a first key Zᵢ together with the numbers associated with said first key Zᵢ in the table, namely the base gᵢ, the prime number pᵢ, and the validity Vᵢ. The key Zᵢ is selected randomly from the table or according to a predefined order for sequencing the keys in the table. If necessary, the key Zᵢ is selected according to its validity period.

During the third step E22, the vehicle A calculates a second key K^{aZ}^{ᵢ} by raising the first key Zᵢ to the power a, in order to obtain Zᵢ^{a}, and then calculating Zᵢ^{a} modulo pᵢ. In other words, the second key is calculated according to the expression K^{aZ}^{ᵢ}=Zᵢ^{a} modulo pᵢ.

### Preparation of the Message M

The method then comprises a step E23 of preparing or creating the message M containing the data to be transmitted, from the first group of numbers containing pᵢ, gᵢ and Zᵢ and using the single-use encryption key or the second encryption key K^{aZ}^{ᵢ} to encrypt the message.

The step E23 of preparing the message M includes a substep E230 during which the vehicle A extracts the numbers pᵢ and gᵢ, associated with the first key Zᵢ, from its storage table or memory, and then a substep E231 of encrypting a second group of numbers containing a, pᵢ and gᵢ by means of the first key Zᵢ used as a symmetric encryption key. For example, the encryption uses the symmetric encryption algorithm AES (Advanced Encryption Standard). The second group of numbers encrypted by AES and the encryption key Zᵢ are denoted (a, pᵢ, gᵢ)^{AES Z}^{ᵢ}. This constitutes a header of the message M.

In the embodiment described, the step E23 of preparing the message M also includes a substep E232 of encrypting the data by means of a symmetric encryption algorithm, for example AES, and using the second key K^{aZ}^{ᵢ} as the symmetric encryption key. The encrypted data are denoted (data)^{AES K}^{^{aZ}}ⁱ and form a body of the message (referred to as “Body”). In other words, the following expression applies: Body=(data)^{AES K}^{^{aZ}}ⁱ.

Alternatively, in order to increase the level of security, the data are concatenated with a random number RAND, for example four “0” or “1” bits, generated by the vehicle A, and the concatenated data (data, RAND) are encrypted by symmetric encryption by means of the second key K^{aZ}^{ᵢ}. In this case, the encrypted data are denoted (data, RAND)^{AES K}^{^{aZ}}ⁱ and form the body of the message. In other words, the following expression applies in this case: Body=(data, RAND)^{AES K}^{^{aZ}}ⁱ.

The step E23 of preparing the message M then includes a substep E233 of signing the message, during which step the vehicle A generates an electronic signature of the message M by means of a digital signature algorithm. In the embodiment described, a signature is generated from the body of the message (Body). The signature of the message M is, for example, an HMAC message authentication code (keyed-hash message authentication code), calculated by means of a hashing function such as SHA-256. In this case, the signature is denoted HMAC K^{aZ}^{ᵢ} (Body)^{SHA-256}. Any other hashing function or signature algorithm could be used.

During a final substep E234 of creating the message M, the following components or elements are concatenated in order: the validity Vᵢ, the header (a, pᵢ, gᵢ)^{AES Z}^{ᵢ} encrypted using the first key Zᵢ, the body of the message (Body)^{AES K}^{^{aZ}}ⁱ encrypted using the second key K^{aZ}^{ᵢ}, and the signature HMAC K^{aZ}^{ᵢ}(Body)^{SHA-256}. The message M thus has a format corresponding to the ordered concatenation of these elements, as shown below:

M={Vᵢ,(a,pᵢ,gᵢ)^{AES Z}^{ᵢ},(data)^{AES K}^{^{aZ}}ⁱ,HMAC K^{aZ}^{ᵢ}((data)^{AES K}^{^{aZ}}ⁱ)^{SHA-256}}={Vᵢ,(a,pᵢ,gᵢ)^{AES Z}^{ᵢ},Body,HMAC K^{aZ}^{ᵢ}(Body)^{SHA-256}}

The message M could have a different format, however. For example, the elements forming the message M could be concatenated in a different order.

The step E23 of preparing the message M is followed by a step E24 of transmitting said message M, through a radio transmission channel, to the vehicle B. The transmitted message M is then received and processed by the vehicle B as described below.

In the embodiment just described, the message is both encrypted and signed by means of the single-use key K^{aZ}ᵢ. Alternatively, depending on the security requirements, the message could be only encrypted by means of the key K^{aZ}^{ᵢ} or only signed by means of the key K^{aZ}^{ᵢ}. In any case, the transmitter vehicle A performs at least one cryptographic operation (encryption or signature) on said message M using the single-use key K^{aZ}^{ᵢ} (i.e. valid only for the message M).

### Method for the Vehicle B to Receive and Process the Received Message M

During a first step E30, the message M is received by the vehicle B. It is then processed in order to verify its authenticity and extract the data carried thereby in plain text.

### Processing of the Message M

During a second step E31, the vehicle B extracts the validity Vᵢ value from the message M.

During a third step E32, the vehicle B extracts the first key Zᵢ which is associated with the validity Vᵢ from its storage table or memory.

During a fourth step E33, the vehicle B decrypts the header of the message by means of the first key Zᵢ and thus obtains the numbers a, pᵢ and gᵢ.

Then, during a fifth step E34, the vehicle B calculates a second key K^{aZ}^{ᵢ} by raising the first key Zᵢ to the power a, in order to obtain Zᵢ^{a}, and then calculating Zᵢ^{a} modulo pᵢ. In other words, the vehicle B calculates the second key K^{aZ}ᵢ according to the following expression K^{aZ}^{ᵢ}=Zᵢ^{a} modulo pᵢ.

The vehicle B then performs a first step E35 of cryptographically processing the received message M, comprising verifying the signature HMAC K^{aZ}^{ᵢ}(Body)^{SHA-256} of the message, using the second key K^{aZ}^{ᵢ} calculated in step E34, in order to verify the authenticity of the message.

If the signature of the received message M is successfully verified, the vehicle B performs a second step E36 of cryptographically processing the received message M, comprising decrypting the body of the message Body=(data)^{AES K}^{^{aZ}}ⁱ using the second key K^{aZ}^{ᵢ} calculated in step E34, in order to obtain the body of the message in plain text. As indicated above, Body contains the data, which may be concatenated with a random number RAND.

If authentication of the message M fails, the step of processing the message M is interrupted. A message signaling that the message was not able to be authenticated can be sent to a user of the vehicle.

The steps E11 and E12 are repeated by the vehicles A and B, respectively, on a regular basis and/or depending on the requirements for keys Zᵢ. For this purpose, each vehicle A, B connects to the back-office server BO and retrieves new series of numbers (gᵢ, pᵢ, Zᵢ, Vᵢ) as described above.

In the above description, it is the vehicle A that transmits data to the vehicle B. Of course, the vehicle B could, in the same way, transmit data to the vehicle A or any other equipment, through a radio transmission channel.

With reference to FIG. 4, each vehicle A, B includes a device for securing radio communications, in particular for securing the radio communications between motor vehicles, comprising means designed to carry out the steps of the transmission method and the steps of the reception method as described above. In particular, each vehicle comprises:
an interface 1 for radio communication through a radio communication channel;
a module 2 for obtaining series of numbers, capable of carrying out the step E11 (E12);
a memory or table 3 for storing the obtained series of numbers;
a random number generator 4;
an encryption/decryption module 5 capable of performing a symmetric encryption/decryption algorithm, in this case AES;
a module 6 for generating a single-use key, capable of carrying out the steps E20 to E22;
a module 7 for preparing or creating a message M for carrying data to be transmitted, capable of carrying out the step E23;
a module 8 for processing a received message M, capable of carrying out the steps E31 to E36;
a module 9 for transmitting and receiving data through the radio interface, in particular capable of carrying out the steps E24 and E30 so as to transmit and receive messages M carrying data.

It will be understood that several modifications and/or improvements that are obvious to a person skilled in the art can be made to the different embodiments of the invention described in the present description, without departing from the scope of the invention as defined by the appended claims.

1. A method for transmitting data, from a motor vehicle, through a radio communication channel, including:
an obtaining step during which said vehicle obtains, from a distribution entity, a plurality of series of numbers each containing
a base gᵢ,
a prime number pᵢ,
a first key Zᵢ, said first key Zᵢ being the result of a calculation comprised of raising the base gᵢ to a power zᵢ, where zᵢ is a secret number selected by said distribution entity, in order to obtain gᵢ^{z}^{ᵢ}, and then calculating gᵢ^{z}^{ᵢ} modulo pᵢ,
a validity number Vᵢ associated with a first group of numbers containing pᵢ, gᵢ and Zᵢ,
where i is an integer which represents an index of said series of numbers, with i=1, 2, . . . , N;
and stores in memory the N series of numbers in a table;
a step of generating a random number a;
a step of calculating a second key K^{aZ}^{ᵢ} by raising the first key Zᵢ to the power a, in order to obtain Zᵢ^{a}, and then calculating Zᵢ^{a} modulo pᵢ;
a step of creating a message M carrying the data from a first group of numbers containing pᵢ, gᵢ and Zᵢ, during which step the vehicle:
encrypts a second group of numbers containing a, pᵢ and gᵢ by means of the first key Zᵢ;
inserts into said message M
the validity number Vᵢ associated with the first key Zᵢ;
the second group of numbers a, pᵢ and gᵢ encrypted by means of the first key Zᵢ, in a header of the message;
the data, in a body of the message; and
performs a cryptographic operation on said message M using the second key K^{aZ}^{ᵢ};
a step of transmitting the message M created by the vehicle through said radio communication channel.

2. The transmission method according to claim 1, wherein the second key K^{aZ}^{ᵢ} is a single-use key intended to be used exclusively for the message M.

3. The transmission method according to claim 1, wherein the vehicle performs at least one of the cryptographic operations from the group comprising an operation for encrypting the content of the body of the message by means of the second key K^{aZ}^{ᵢ} and a cryptographic operation for signing the message by means of the second key K^{aZ}^{ᵢ}.

4. The transmission method according to claim 3, wherein the vehicle performs said cryptographic operation using the second key K^{aZ}^{ᵢ} exclusively on the body of the message (Body).

5. The transmission method according to claim 1, wherein the vehicle inserts a random number r into the body of the message.

6. A method for a second vehicle to receive a message M transmitted by a first vehicle, through a communication channel, according to the transmission method according to claim 1, wherein said reception method includes:
an obtaining step during which said second vehicle obtains, from said distribution entity, and stores in memory, in a table, a plurality of series of numbers each containing:
a base gᵢ,
a prime number pᵢ,
a first key Zᵢ, said first key Zᵢ being the result of a calculation comprised of raising the base gᵢ to a power zᵢ, where zᵢ is a secret number selected by said distribution entity, in order to obtain gᵢ^{z}^{ᵢ}, and then calculating gᵢ^{z}^{ᵢ} modulo pᵢ,
a validity number Vᵢ associated with a first group of numbers containing pᵢ, gᵢ and Zᵢ,
where i is an integer which represents an index of said series of numbers, with i=1, 2, . . . , N;
a step of extracting the validity number Vᵢ from the received message M;
a step of extracting the first key Zᵢ associated with the validity number Vᵢ from the table stored in memory;
a step of decrypting the header of the message by means of the first key Zᵢ, in order to obtain the numbers a, pᵢ and gᵢ;
a step of calculating a second key K^{aZ}^{ᵢ} comprised of raising the first key Z to a power a, in order to obtain Zᵢ^{a}, and then calculating Zᵢ^{a} modulo pᵢ,
at least one step of cryptographically processing the received message M by means of the second key K^{aZ}^{ᵢ}.

7. The reception method according to claim 6, wherein, when the message M is signed, the second vehicle verifies the authenticity of the message M by verifying the validity of the signature by means of the second key K^{aZ}^{ᵢ}.

8. The method according to claim 6, wherein, when the message is encrypted, the second vehicle decrypts the message using the second key K^{aZ}^{ᵢ} as a decryption key.

9. A device for securing radio communications for a motor vehicle, comprising means designed for transmitting and receiving data over a radio communication channel; said means including:
an interface for radio communication through said radio communication channel;
a module adapted to obtain from a distribution entity a series of numbers, each of which contains a base gᵢ, a prime number pᵢ, a first key Zᵢ, and a validity number Vᵢ associated with said first key Zᵢ; wherein a first key Zᵢ, said first key Zᵢ being the result of a calculation comprised of raising the base gᵢ to a power zᵢ, where zᵢ is a secret number selected by said distribution entity, in order to obtain gᵢ^{z}^{ᵢ}; and wherein i is an integer between 1 and N;
a memory or table for storing the obtained series of numbers;
a random number generator;
an encryption/decryption module capable of performing a symmetric encryption/decryption algorithm;
a module for generating a single-use key; said module being adapted to generate a random number a, calculate a second key K^{aZ}^{ᵢ} by raising the first key Zᵢ to the power a, in order to obtain zᵢ^{a}, and then calculate Zᵢ^{a} modulo pᵢ;
a module for preparing or creating a message for carrying data to be transmitted, said module being adapted to
encrypt a second group of numbers containing a, pᵢ and gᵢ of by means of the first key Zᵢ;
insert into said message M
the validity number Vᵢ associated with the first key Zᵢ;
the second group of numbers a, pᵢ and qᵢ encrypted by means of the first key Zᵢ, in a header of the message;
the data, in a body of the message; and
perform a cryptographic operation on said message M using the second key K^{aZ}^{ᵢ};
a module for processing a received message, said module being adapted to:
extract the validity number Vᵢ from the received message M;
extract the first key Zᵢ associated with the validity number Vᵢ from the table stored in memory;
decrypt the header of the message by means of the first key Zᵢ, in order to obtain the numbers a, pᵢ and gᵢ;
calculate a second key K^{aZ}^{ᵢ} comprised of raising the first key Zᵢ to a power a, in order to obtain Zᵢ^{a}, and then calculating Zᵢ^{a} modulo pᵢ, and
at least one step of cryptographically processing the received message M by means of the second key K^{aZ}^{ᵢ}, and
a module for transmitting and receiving data through the radio interface so as to transmit and receive messages M carrying data.

10. A motor vehicle including a security device according to claim 9.
